(19) United States
(12) Patent Application Publication
(10) Pub. No.: US 2021/0071963 A1
(43) Pub. Date: Mar. 11, 2021

(54) Bendable Flat Heat Pipe Devices, Systems, and Methods

(71) Applicant: Roccor, LLC, Longmont, CO (US)

(72) Inventors: Michael Hulse, Erie, CO (US); Mario Saldana, Thornton, CO (US); Steven Isaacs, Loveland, CO (US); Madison Kelley, Littleton, CO (US); Zachary McConnel, Centennial, CO (US)

(21) Appl. No.: 16/999,176

(22) Filed: Aug. 21, 2020

Related U.S. Application Data
(60) Provisional application No. 62/889,878, filed on Aug. 21, 2019.

(51) Int. Cl. F28D 15/04; B23P 15/26

(52) U.S. Cl. CPC F28D 15/04; B23P 2700/09; B23P 15/26

(57) ABSTRACT

Methods, systems, and device for bendable flat heat pipes are provided in accordance with various embodiments. For example, some embodiments include a device that includes one or more containment layers. A wick and vapor layer may be positioned between two containment layers or between two portions of a containment layer; the wick and vapor layer may include both wick and vapor channels. Some embodiments include multiple cross ribs that may run laterally on either side or both sides of the wick and vapor layer. In some embodiments, the containment layer(s), the wick and vapor layer, and the multiple cross ribs are bonded with each other to form the device. In addition, the device may be charged with a working fluid.

### CROSS-REFERENCES TO RELATED APPLICATIONS

This application is a non-provisional patent application claiming priority benefit of U.S. provisional patent application Ser. No. 62/889,878 filed on Aug. 21, 2019 and entitled “BENDABLE THIN FLAT HEAT PIPE DEVICES, SYSTEMS, AND METHODS,” the entire disclosure of which is herein incorporated by reference for all purposes.

### BACKGROUND

The miniaturization of electronic components and science instruments has led to the widespread adoption of increasingly small spacecraft platforms like CubeSats. Some applications, however, have encountered significant challenges cooling higher power instruments. There may a need for new tools and techniques to facilitate cooling for different applications, including, but not limited to higher power instructions for small spacecraft or other platforms.

### SUMMARY

Bendable flat heat pipe devices, systems, and method are provided in accordance with various embodiments. For example, some embodiments include a bendable flat heat pipe that may include one or more containment layers and a wick and vapor layer contained between the one or more containment layers. The wick and vapor layer may include one or more wick channels and one or more vapor channels. Some embodiments of the bendable flat heat pipe include multiple cross ribs positioned between the wick and vapor layer and at least one of the one or more containment layers. In some embodiments, the multiple cross ribs are oriented across the one or more vapor channels and the one or more wick channels. In some embodiments, the multiple cross ribs are bonded with the wick and vapor layer. Some embodiments of the bendable flat heat pipe include a working fluid contained within the bendable flat heat pipe.

In some embodiments of the bendable flat heat pipe, the wick and vapor layer includes one or more metal meshes. In some embodiments, the one or more metal meshes include multiple metal meshes that include at least a first metal mesh and a second metal mesh where the first metal mesh includes more pores per unit area than the second metal mesh. In some embodiments, the multiple metal meshes are bonded with each other. In some embodiments, the one or more vapor channels are formed from removing material from the one or more metal meshes of the wick and vapor layer.

In some embodiments of the bendable flat heat pipe, the one or more containment layers includes a first containment layer that is folded to form a first portion and a second portion; the wick and vapor layer may be contained between the first portion of the first containment layer and the second portion of the first containment layer. In some embodiments of the bendable flat heat pipe, the one or more containment layers includes a first containment and a second containment layer; the wick and vapor layer may be contained between the first containment layer and the second containment layer.

Some embodiments include a method of forming a bendable flat heat pipe. The method may include forming a wick and vapor layer; the wick and vapor layer may include one or more wick channels and one or more vapor channels. The method may include containing the wick and vapor layer between one or more containment layers. Some embodiments of the method of forming the bendable flat heat pipe include positioning multiple cross ribs between the wick and vapor layer and at least one of the one or more containment layers. Some embodiments include bonding the multiple cross ribs with the wick and vapor layer. Some embodiments include removing material from a metal layer to form the multiple cross ribs. Some embodiments include charging the bendable flat heat pipe with a working fluid.

Some embodiments of the method of forming the bendable flat heat pipe include forming the wick and vapor layer includes bonding multiple metal meshes with each other. In some embodiments, the multiple metal meshes include at least a first metal mesh and a second metal mesh where the first metal includes more pores per unit area than the second metal mesh.

In some embodiments of the method of forming the bendable flat heat pipe, forming the wick and vapor layer includes removing material from one or more metal meshes that form the wick and vapor layer to form the one or more vapor channels. In some embodiments, containing the wick and vapor layer between the one or more containment layers include bonding the wick and vapor layer with the one or more containment layers. In some embodiments, containing the wick and vapor layer between one or more containment layers includes folding a first containment layer such that the wick and vapor layer is contained between a first portion of the first containment layer and a second portion of the first containment layer.

Some embodiments include methods, systems, and/or devices as described in the specification and/or shown in the figures.

The foregoing has outlined rather broadly the features and technical advantages of embodiments according to the disclosure in order that the detailed description that follows may be better understood. Additional features and advantages will be described hereinafter. The conception and specific embodiments disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of different embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a device in accordance with various embodiments.

FIG. 2A shows aspects of a device in accordance with various embodiments.

FIG. 2B shows aspects of a device in accordance with various embodiments.

FIG. 3 shows aspects of a device in accordance with various embodiments.

FIG. 4 shows aspects of a device in accordance with various embodiments.

FIG. 5 shows aspects of a device in accordance with various embodiments.

FIG. 6 shows aspects of a device in accordance with various embodiments.

FIG. 7 shows devices in accordance with various embodiments.

FIG. 8 shows aspects of a device in accordance with various embodiments.

FIG. 9 shows a system in accordance with various embodiments.

FIG. 10 shows a flow diagram of a method in accordance with various embodiments.

### DETAILED DESCRIPTION

This description provides embodiments, and is not intended to limit the scope, applicability, or configuration of the disclosure. Rather, the ensuing description will provide those skilled in the art with an enabling description for implementing embodiments of the disclosure. Various changes may be made in the function and arrangement of elements.

Thus, various embodiments may omit, substitute, or add various procedures or components as appropriate. For instance, it should be appreciated that the methods may be performed in an order different than that described, and that various stages may be added, omitted, or combined. Also, aspects and elements described with respect to certain embodiments may be combined in various other embodiments. It should also be appreciated that the following systems, devices, and methods may individually or collectively be components of a larger system, wherein other procedures may take precedence over or otherwise modify their application.

Bendable flat heat pipe devices, systems, and methods are provided in accordance with various embodiments. For example, some embodiments include a thin flat heat pipe that may be easily bendable without kinking and restricting working fluid flow inside of the heat pipe. Vapor channels may be formed as longitudinal slots in a capillary liquid wick layer; cross ribs may run laterally on either side of the wick and vapor layer and may be encapsulated in a hermetically seal thin metal foil pouch and may be charged with a working fluid. The cross ribs may be sized such to allow micro-buckles with limited amplitude to form at a given bend radius but without protruding into the wick and vapor layer and interrupting heat transport.

The tools and techniques provided in accordance with various embodiments may address a variety of problems with new and innovative devices, systems, and/or methods. For example, the miniaturization of electronic components and science instruments has led to the widespread adoption of increasingly small spacecraft platforms like CubeSats. Some applications, however, have encountered significant challenges cooling the higher power instruments. The variety of tools and techniques provided in accordance with various embodiments may help address these issues.

Furthermore, the adoption of smaller form factors across a wide array of spacecraft platforms presents new thermal challenges, the densification of the electronics packages has introduced the need for advanced thermal management in general. Most spacecraft components have a range of allowable temperatures for optimal performance as well as survivability. Temperatures on these platforms are often regulated utilizing a variety of passive thermal management technologies like MLI materials, paint, sun shields, flexible thermal straps, thermal storage units, thermal louvers, deployable radiators, and heat pipes. The tools and techniques provided in accordance with various embodiments may provide new and innovative devices, systems, and/or methods to address these challenges.

Also, the microgravity environment also may present unique challenges for heat pipes. Heat pipes in microgravity may operate at significantly higher temperatures than they do on earth. This may generally be due to the lack of gravity-driven natural convection. The tools and techniques provided in accordance with various embodiments may provide new and innovative devices, systems, and/or methods to address these challenges.

Traditional round heat pipes can generally be flattened in order to interface with planar surfaces. This practice, however, may limit how thin a commercially available heat pipe can be. Some heat pipes may be approximately 2 mm in thickness and only 4.83 mm wide, for example. Thinner flat heat pipes may be available that can be made as thin as 1.2 mm and may be bendable, however, these heat pipes are generally limited in only being able to carry up to 5 watts of power in the horizontal orientation; these heat pipes may also facing kinking problems, where the wick and/or vapor channels of the heat pipe may be cut off or otherwise impaired when the pipe is bent. Additionally, these thin flat heat pipes are generally not rated for space applications, largely due to limited internal pressure capability. The tools and techniques provided in accordance with various embodiments may provide new and innovative devices, systems, and/or methods to address these issues. For example, some embodiments may provide for thin flat heat pipes that are bendable, while avoiding problems with kinking that may cut off the wick and/or vapor channels of the heat pipe and also being able to handle higher power devices to cool. Merely by way of example, some embodiments provide for extremely thin (<1 mm), easily bent, high heat flux, heat pipes.

The devices, systems, and methods provided in accordance with various embodiments have a wide variety of application. For example, some embodiments are applicable to space-rated flexible thermal straps. Some embodiments enable efficient heat transfer by dissipating a wide range of heat loads in widely varying environments. Further, in addition to improving on the cooling capability of current thermal strap technologies, the compact, thin, and flexible construction of the various thermal straps in accordance with various embodiments may involve less of the limited spacecraft mass and volume than competing thermal strap designs.

Some embodiments have other military and commercial applications where thermal management is also a considerable need. Terrestrial-based applications include military and commercial aviation, military electronics, and consumer electronics (e.g., computers, cell phones, etc.) among several others. Some embodiments have applications to small satellite designs that may be reaching the thermal design limits for the significant processing or power dissipation of the designs. Some applications may include internet from space constellations and Earth imaging. Electronics cooling is generally a large commercial and defense market that may benefit from high conductivity materials in accordance with various embodiments.

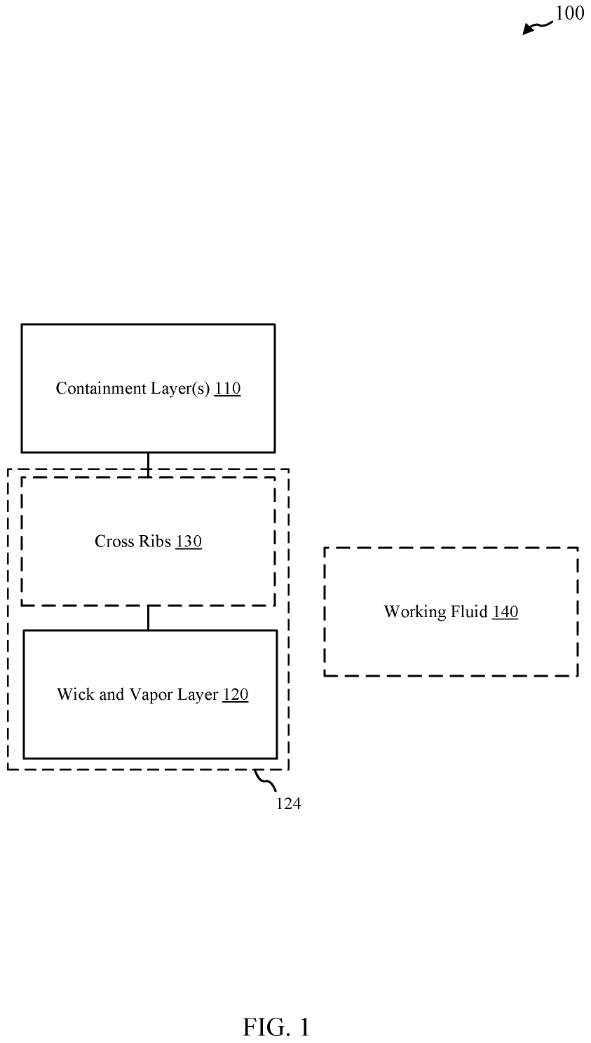

Turning now to FIG. 1, a device 100 is provided in accordance with various embodiments. Device 100 may be referred to as a heat pipe, such as a bendable flat heat pipe; the device may be referred to as a bendable thin flat heat pipe.

Device 100 may include one or more containment layers 110 and a wick and vapor layer 120 contained between the one or more containment layers 110. The wick and vapor layer 120 may include one or more wick channels and one or more vapor channels. The wick and vapor layer 120 may be formed such that the one or more vapor channels are formed between the one or more wick channels; the one or more wick channels may be referred to as portions of a wick structure. The wick and vapor layer may be described as a lateral series of one or more wick channels and one or more vapor channels; this may form a lateral pattern.

Some embodiments of the device 100 include multiple cross ribs 130 positioned between the wick and vapor layer 120 and at least one of the one or more containment layers 110. In some embodiments, the multiple cross ribs 130 are oriented across the one or more vapor channels and the one or more wick channels of the wick and vapor layer 120. In some embodiments, the multiple cross ribs 130 are bonded with the wick and vapor layer 120. The combination of the multiple cross ribs 130 and the wick and vapor layer 120 may be referred to as a wick and vapory layer with cross ribs 124. Some embodiments of the device 100 include a working fluid 140 contained within the device 100.

In some embodiments of the device 100, the wick and vapor layer 120 includes one or more metal meshes. In some embodiments, the one or more metal meshes include multiple metal meshes that include at least a first metal mesh and a second metal mesh where the first metal mesh includes more pores per unit area than the second metal mesh. In some embodiments, the multiple metal meshes are bonded with each other. In some embodiments, the one or more vapor channels are formed from removing material from the one or more metal meshes of the wick and vapor layer 120. In some embodiments, the wick and vapor layer 120 may be formed through aligning multiple wick structures spaced apart to form vapor channels between the wick structures (or wick channels).

In some embodiments of the device 100, the one or more containment layers 110 includes a first containment layer that is folded to form a first portion and a second portion; the wick and vapor layer 120 may be contained between the first portion of the first containment layer and the second portion of the first containment layer. In some embodiments of the device 100, the one or more containment layers 110 includes a first containment and a second containment layer; the wick and vapor layer 120 may be contained between the first containment layer and the second containment layer.

Device 100 may include the one or more containment layers 110; the one or more containment layers 110 may include, but are not limited to, metal foils such as copper foils, though other types of metal foils may be utilized. The containment layer(s) 110 may be referred to as casings and/or an envelopes in some embodiments. The wick and vapor layer 120 may be positioned between two containment layers 110 or between two portions of a containment layer 110; the wick and vapor layer 120 may include both wick and vapor channels in the same plane with each other. Some embodiments include the multiple cross ribs 130 that may run laterally on either or both sides of the wick and vapor layer 120. In some embodiments, the containment layer(s) 110, the wick and vapor layer 120, and the multiple cross ribs 130 are diffusion bonded together to form the device 100. In addition, device 100 may be charged with a working fluid 140; the working fluid 140 may include, but is not limited to, at least ammonia, acetone, methanol, water, or ethyl alcohol. The working fluid 140 may include a variety of refrigerants in general. In some embodiments, the working fluid 140 may include different cryogenic liquids, such as liquid nitrogen, liquid helium, or liquid hydrogen, for example. Some embodiments may utilize a working fluid 140 suitable for high temperature applications, such as liquid sodium or other liquid metals.

Some embodiments include the wick and vapor layer 120, which may be formed such that wick structure(s) and vapor channel(s) may be part of the same layer. The wick structures may also be referred to as wick channels. In some embodiments, the vapor channel(s) may be formed as slots through the wick structure. For example, vapor channel(s) may be cut as channels within the wick structure(s) to form the vapor layer in the same plane as the wick structures; this may involve removing material from the wick structure to form the vapor channel(s) within the wick structure resulting in the overall wick and vapor layer 120.

The wick structure(s) may include capillary wick structure(s). The wick structures may be formed from porous materials. Merely by way of example, the wick structures may be formed from one or more mesh layers, one or more sturdy metal foams, and/or one or more sintered materials. In some embodiments, the wick structure(s) may be formed from stacked meshes, where the various mesh layers may have different thicknesses; some meshes may utilized woven screens. For example, some embodiments utilize copper woven screen(s) over various mesh sizes. In general, the wick and vapor layer 120 may be formed from a variety of metal materials including, but limited to, copper, aluminum, titanium, or stainless steel. Some embodiments utilize a non-metallic materials, like polymers.

The multiple cross ribs 130 may be positioned on other either side or both sides of the wick and vapor layer 120. The multiple cross ribs 130 may help keep the outer envelope or containment layer(s) 110 from ballooning down into the vapor channels of the wick and vapor layer 120. The multiple cross ribs 130 may also force portions of the containment layer 110 to wrinkle when it buckles so that it does not kink, thus avoiding cutting off liquid and/or vapor transport within the wick and vapor layer 120. The spacing of the cross ribs 130 may configured such that a wavelength of buckle is built into spacing to avoid kinking that may cut off the vapor channels, for example. The cross ribs may be formed from a variety of materials including, but not limited to, copper, aluminum, stainless steel, or titanium. The cross ribs may be made from non-metallic materials, such as composites.

In general, the cross ribs 130 run across the wick and vapor layer 120 such that the cross ribs 130 are perpendicular to the vapor channels and/or wick walls of the wick and vapor layer 120. The cross ribs 130 may force the size of wrinkle of portions of the containment layer 110 when the device 100 may be bent. As noted above, this may help avoid the problems of ballooning and/or kinking. When the device 100 either curves or is bent, it may form small buckles in portions of the containment layer 110. The use of cross ribs 130 may help reinforce the bending, while controlling the wavelength of the buckles to avoid kinking, which may cut off the vapor channels in the wick and vapor layer 120. The cross ribs 130 may also provide structural support to device 100.

The one or more containment layers 110 may include multiple containment layers; some embodiments may fold over a containment layer 110 to form an upper and lower portion on either side of the wick and vapor layer 120. The one or more containment layers 110 may be formed from a variety of materials including, but not limited to, copper, aluminum, stainless steel, or titanium. The one or more containment layers 110 may be referred to as one or more metal foils. Some embodiments utilize non-metallic material layers, like polymers.

The use of diffusion bonding (also known as thermocompression bonding) may be utilized to join different material layers of device 100 together to help facilitate the ability to carry internal vapor pressure; for example, diffusion bonding may be utilized to join the wick and vapor layer 120, cross ribs 130, and containment layer(s) 110 together in some embodiments. Thermocompression bonding may have several favorable factors, including, but not limited to: may be ideal for flat, thin, COTS materials; may have high integrity interfacial bonds with strengths similar to welding; may include bonding of similar materials without the introduction of dissimilar materials; may make highly hermetic bonds achievable; and/or may be a scalable method for commercial manufacturing of bendable thin heat pipes, such as device 100. Other tools and techniques may be utilized to join the different layers, from the wick and vapor layer(s) 120, to the cross ribs 130, to the containment layers including, but not limited to, adhesive bonding, or ultrasonic welding.

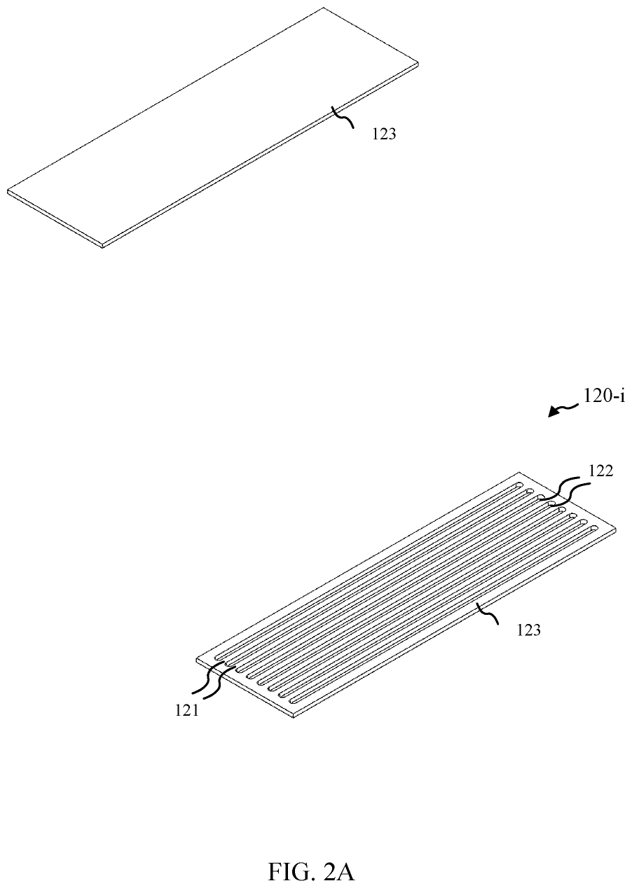

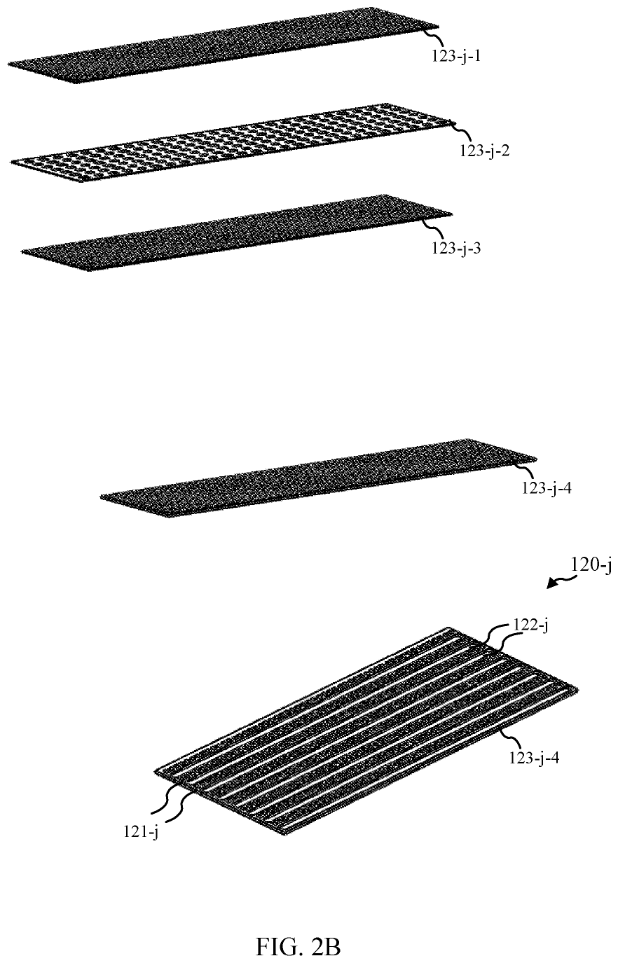

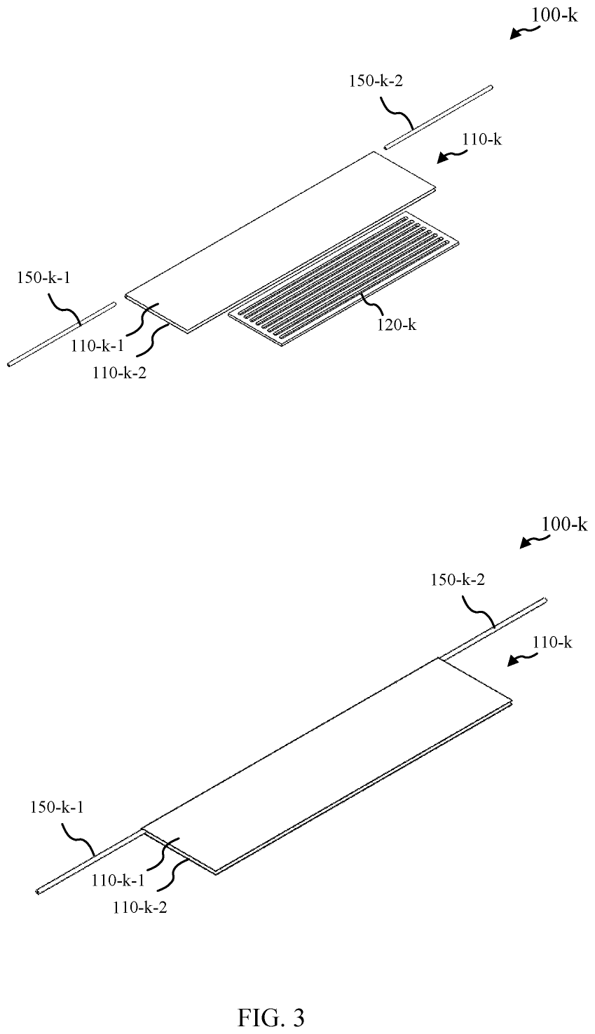

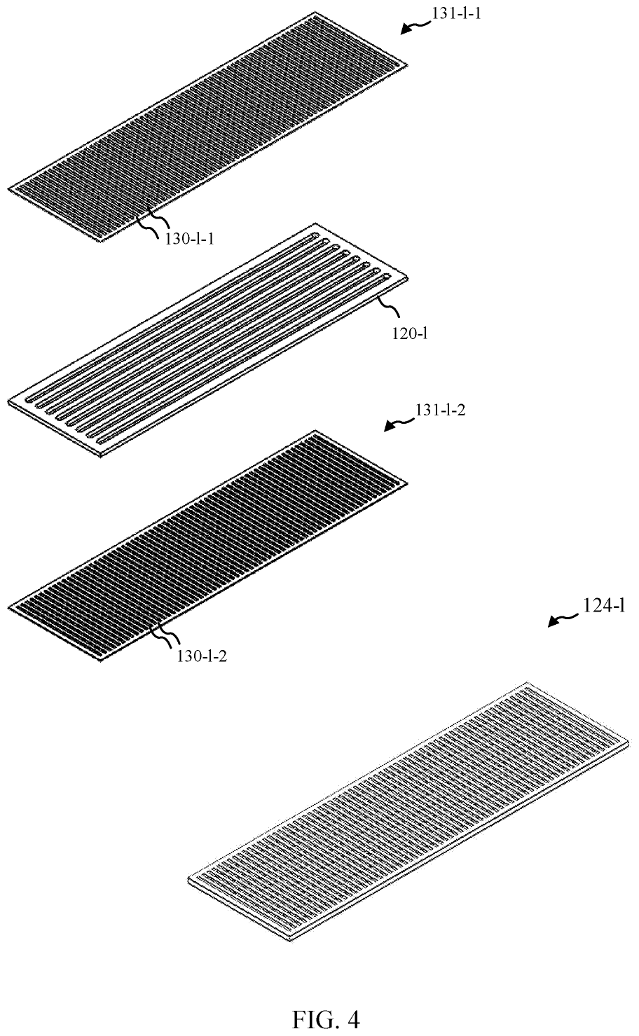

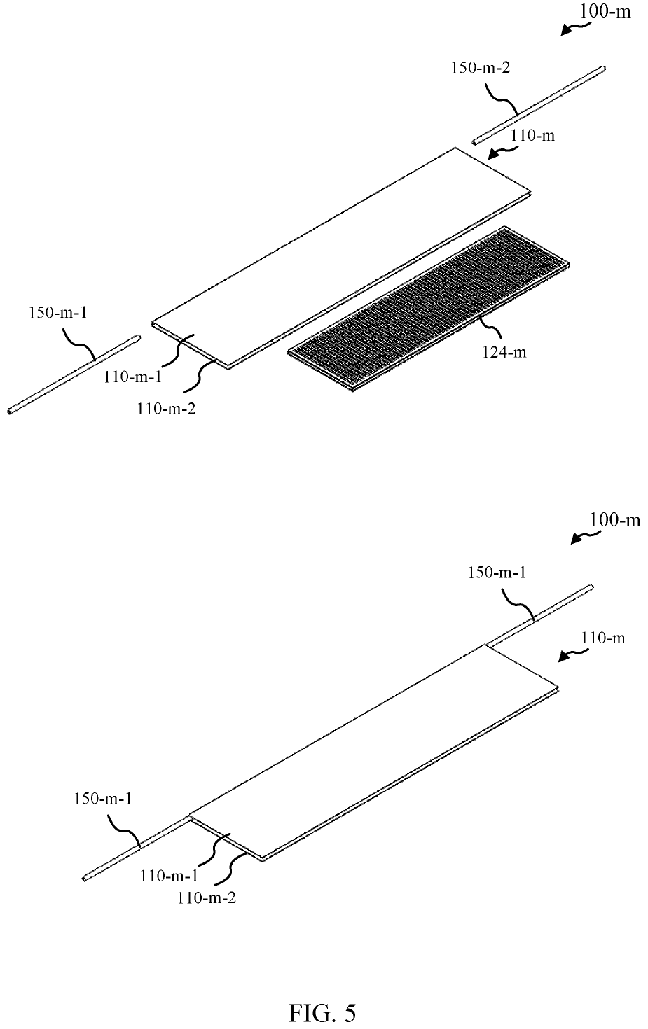

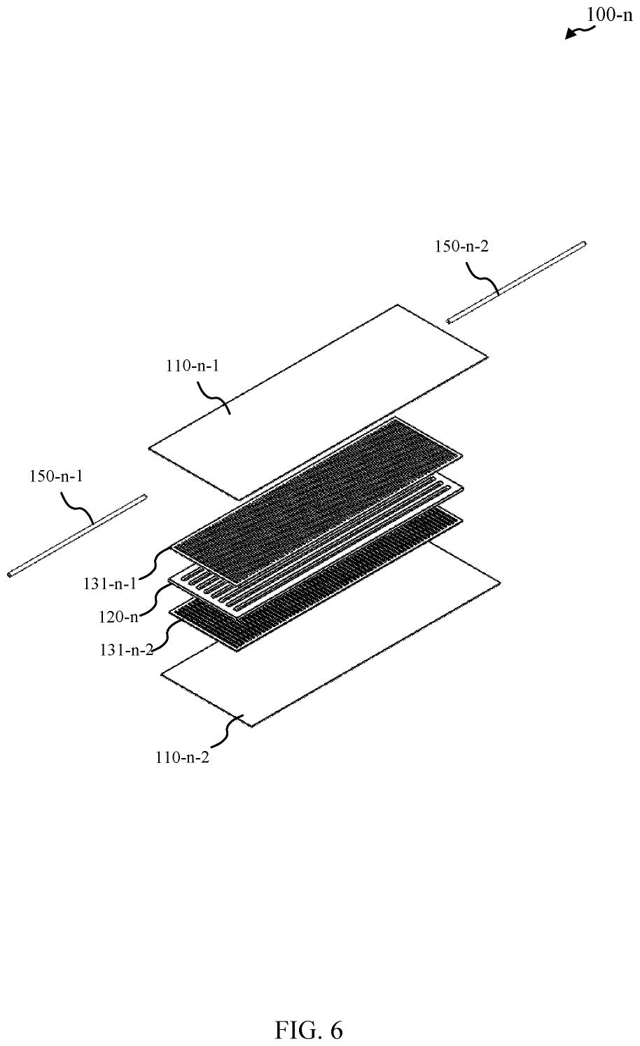

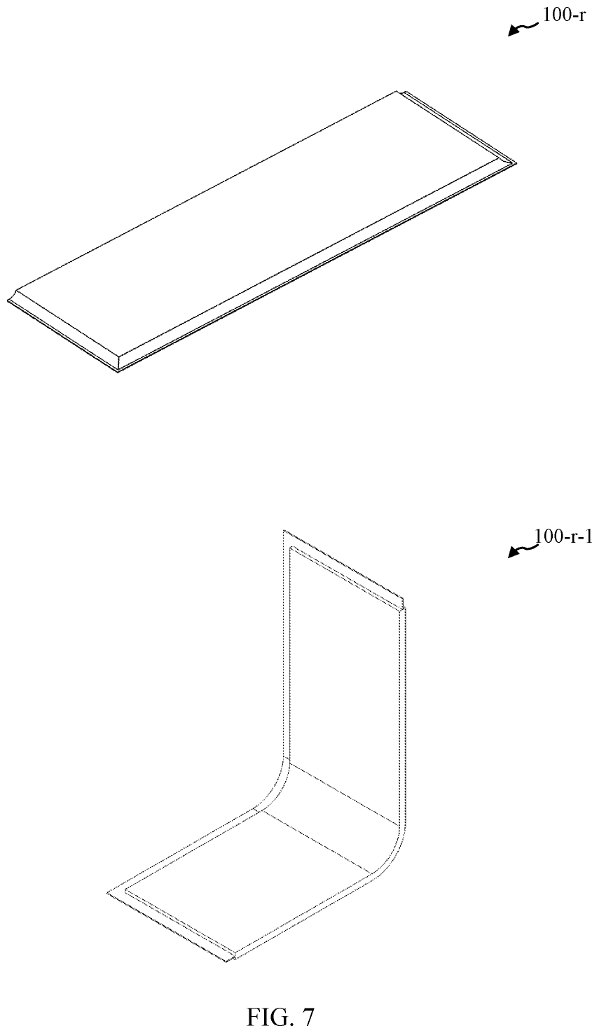

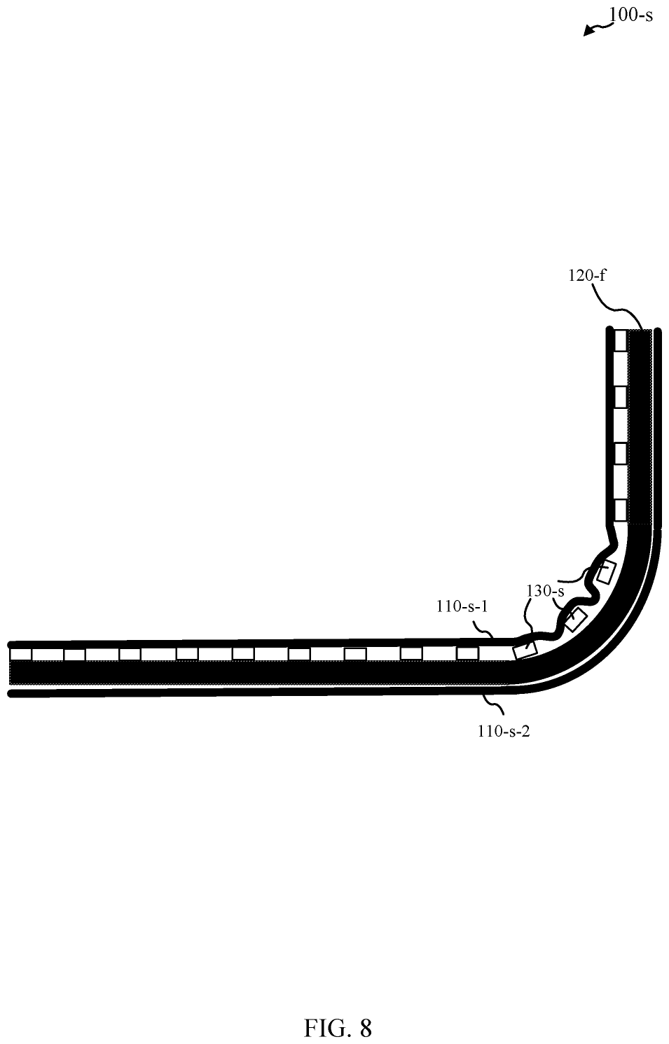

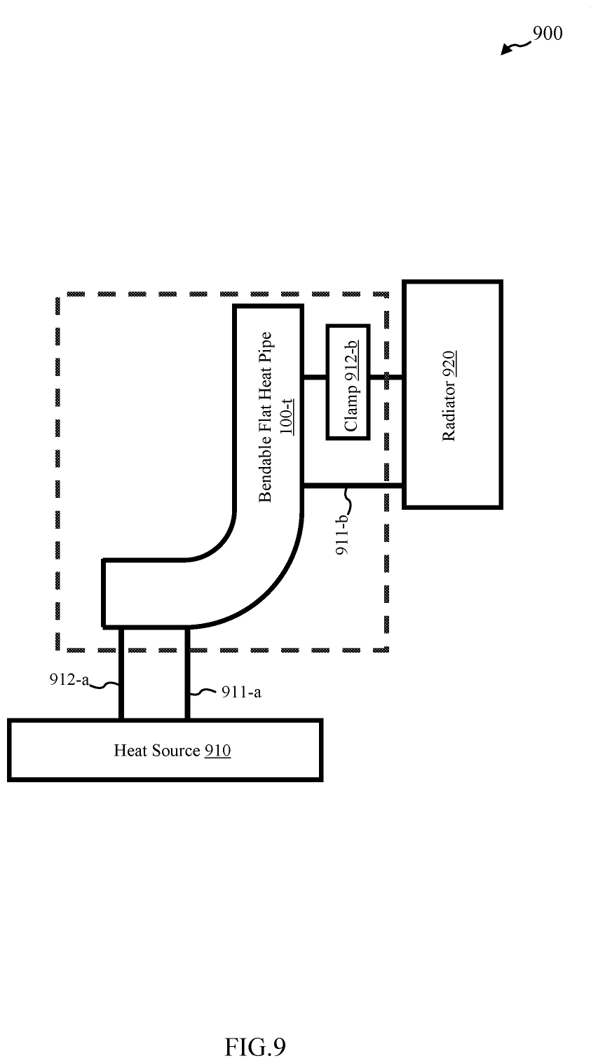

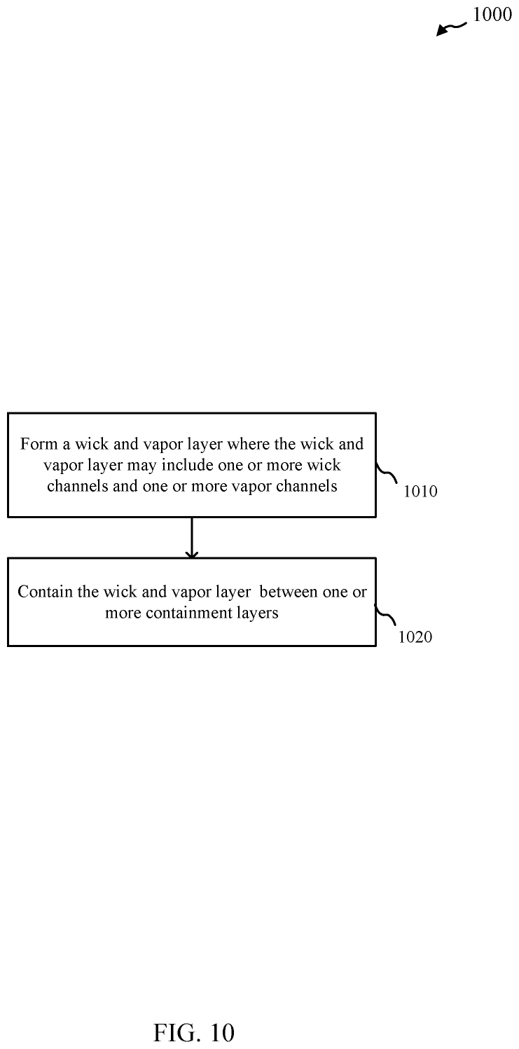

A variety of dimensions may be utilized for the devices 100 shown with respect to FIG. 1 (and the specific examples described with respect to FIG. 2A, FIG. 2B, FIG. 3, FIG. 4, FIG. 5, FIG. 6, FIG. 7, FIG. 8, FIG. 9 and FIG. 10) The following dimensions and power dissipations are merely provided as examples. Other dimensions and power dissipations may be utilized. Some embodiments have a heat pipe thickness less than or equal to 1 mm. For example, some embodiments include remarkably thin heat pipes, less than 0.7 mm that have demonstrated some of the highest performance to date, dissipating over 20 watts of power. Some embodiments include cross ribs with thickness of 0.010 inches, spacing of 0.035 inches, rib width of 0.040 inches, and/or total width of 1.5 inches. Some embodiments include a wick structure formed from 40 mesh/200 mesh, with 9 alternating layers, and/or a total width of 1.5 inches. Some embodiments include vapor channels with channel width of 0.09 inches, channel spacing of 0.0755 inches, and/or channel radius of 0.045 inches. Some embodiments include one or more containment layers (or cases) with thickness of 0.003 inches and/or border width of 0.25 inches.

Device 100 and the various examples provided herein may provide a variety of other benefits and differences from other heat pipe tools and techniques. For example, the viscous flow resistance in the vapor channels of flat heat pipe 100, traditionally ignored in heat pipes as negligible, may actually be a key performance parameter in thin heat pipes in accordance various embodiments that may involve significant consideration. Some embodiments incorporate more open vapor channel(s) with the wick channel(s) moved into the same plane as noted. Some embodiments have also been tested to internal pressures as high as 400 psi with minimal out-of-plane deflections.

Turning now to FIG. 2A, an example of wick and vapor layer construction is provided in accordance with various embodiments. The upper image shows first a generally wick structure 123. The wick structure 123 may be formed from a variety of porous materials, such as metal wire meshes (which may also be referred to as metal screens) and/or metal foams. Some embodiments utilize copper meshes, for example, though other metals may be utilized, including, but not limited to, aluminum, titanium, or stainless steel. Some embodiments utilize a non-metallic materials, like polymers. In some embodiments, the wick structure 123 is formed from multiple layers, such as multiple metal mesh layers. The multiple metal mesh layers may be bonded together utilizing a variety of tools and techniques, such as diffusion bonding and/or adhesives.

The construction of a wick and vapor layer 120-i, shown in the lower portion of FIG. 2A, may then be formed through removing material from the wick structure 123. Wick and vapor layer 120-i may be an example of wick and vapor layer 120 of FIG. 1. As a result, one or more wick channels 121 where material from the wick structure 123 has been left, while one or more vapor channels 122 may formed through removing material from the wick structure 123. In this example, two wick channels are pointed out as are two vapor channels, though embodiments may include more or fewer wick channels 121 and/or vapor channels 122. Material from the wick structure 123 may be removed to form the vapor channels 122 utilizing a variety of tools and techniques including, but limited to, milling, drilling, laser cutting, water jetting, or EDM cutting. As shown, the wick and vapor layer 120-i may be formed such that the one or more vapor channels 122 are formed between the one or more wick channels 121; the one or more wick channels 121 may be referred to as portions of a wick structure 123. The wick and vapor layer 120-i may be described as a lateral series of one or more wick channels 121 and one or more vapor channels 122; this may form a lateral pattern.

FIG. 2B shows another example of wick and vapor layer construction in accordance with various embodiments. The top portion of FIG. 2B first shows three wick structures 123-j-1, 123-j-2, and 123-j-3. The wick structures 123-j-1, 123-j-2, and 123-j-3 may be formed from a variety of porous materials, such as metal wire meshes (which may also be referred to as metal screens) and/or metal foams. Some embodiments utilize copper meshes, for example, though other metals may be utilized, including, but not limited to, aluminum, titanium, or stainless steel. Some embodiments utilize a non-metallic materials, like polymers. In this example, wick structures 123-j-1 and 123-j-3 are show as metal meshes or screens that include more pores per unit area that wick structure 123-j-2, also show as a metal mesh or screen. Wick structures 123-j-1 and 123-j-3 may be referred to as fine meshes, while wick structure 123-j-2 may be referred as a coarse mesh. While this example utilizes three wick structures, some embodiments may utilize more or fewer wick structures.

The middle portion of FIG. 2B shows the resulting wick structure 123-j-4 that may be formed by bringing the wick structures 123-j-1, 123-j-2, and 123-j-3 together. The multiple metal mesh layers 123-j-1, 123-j-2, and 123-j-3 may be bonded together to forming the wick structure 123-j-4 utilizing a variety of tools and techniques, such as diffusion bonding, adhesives, or ultrasonic welding.

The construction of a wick and vapor layer 120-j, shown in the lower portion of FIG. 2B, may then be formed through removing material from the wick structure 123-j-4. Wick and vapor layer 120-j may be an example of wick and vapor layer 120 of FIG. 1. As a result, one or more wick channels 121-j where material from the wick structure 123-j-4 has been left, while one or more vapor channels 122-j may be formed through removing material from the wick structure. In this example, two wick channels 121-j are pointed out as are two vapor channels 121-j, though embodiments may include more or fewer wick channels 121-j and/or vapor channels 122-j. Material from the wick structure 123-j-4 may be removed to form the vapor channels 122-j utilizing a variety of tools and techniques including, but limited to, milling, drilling, laser cutting, water jetting, or EDM cutting. As shown, the wick and vapor layer 120-j may be formed such that the one or more vapor channels 122-j are formed between the one or more wick channels 121-j; the one or more wick channels 121-j may be referred to as portions of a wick structure 123-j. The wick and vapor layer 120-j may be described as a lateral series of one or more wick channels 121-j and one or more vapor channels 122-j; this may form a lateral pattern

Some embodiments benefit from having the multiple wick structures 123-j-1, 123-j-2, and 123-j-3 bonded together prior to material being removed to form the vapor channels 122-j. This may facilitate maintaining alignment and/or enhancing thermal contact of the layers of the wick and vapor layer 120-j.

Turning now to FIG. 3, aspects of assembly of a bendable flat heat pipe 100-k in accordance with various embodiments are provided. Device 100-k may be an example of aspects of device 100 of FIG. 1. The top portion of FIG. 3 shows several components, including a wick and vapor layer 120-k along with a containment layer 110-k. The wick and vapor layer 120-k may be an example of the wick and vapor layer 120 of FIG. 1, FIG. 2A, and/or FIG. 2B. The containment layer 110-k may be an example of the containment layer 110 of FIG. 1. In this example, the containment layer 110-k may be folded to form a first portion 110-k-1 and a second portion 110-k-2. Through folding the containment layer 110-k as shown, it may reduce the number of edges that may need to be sealed. The wick and vapor layer 120-k may be shown prior to being positioned between the first portion 110-k-1 and the second portion 110-k-2. Charging tubes 150-k-1 and 150-k-2 are also shown, which may facilitate charging the bendable flat heat pipe 100-k with a working fluid.

The lower portion of FIG. 3 shows the bendable flat heat pipe 100-k after the wick and vapor layer 120-k may be contained between the first portion 110-k-1 of the containment layer 110-k and the second portion 110-k-2 of the containment layer 110-k, and thus may be obscured from view. The charging tubes 150-k-1 and 150-k-2 may be positioned proximal to the bend of the containment layer 110-k formed between the two portions 110-k-1 and 110-k-2. The free edges of the two portions 110-k-1 and 110-k-2 may be bonded together utilizing a variety of techniques, including, but not limited to diffusion bonding, seam welding, soldering, adhesive bonding, laser welding, or ultrasonic welding. Some embodiments utilize hermetic sealing. FIG. 7 shows an example of a resulting device.

FIG. 4 shows assembly aspects of a bendable thin heat pipe in accordance with various embodiments. The top portion of FIG. 4 shows a wick and vapor layer 120-l, which may be an example of the wick and vapor layer 120 of FIG. 1, FIG. 2A, FIG. 2B, and/or FIG. 3. In addition, two cross rib structures 131-l-1 and 131-l-2 are shown, where the first cross rib structure 131-l-1 includes multiple cross ribs 130-l-1 and the second cross rib structure 131-l-2 includes multiple cross ribs 131-l-2. The two cross rib structures 131-l-1 and 131-l-2 may be formed one or more metal layers with material removed, leaving behind the cross ribs 130-l-1 and 130-l-2. Some embodiments utilize individual separate cross ribs rather than a cross rib structure. Some embodiments include cross ribs on one side of the wick and vapor layer 120-l.

The three layers include the first cross rib structure 130-l-1, the wick and vapor layer 120-l, and the second cross rib structure 130-l-2 may be bonded together, such as through diffusion bonding, adhesive bonding, or ultrasonic welding, to form a wick and vapor layer with cross rib structure 124-l, shown in the lower portion of FIG. 4, which may be an example of the wick and vapor layer with cross rib structure 124 of FIG. 1.

Turning now to FIG. 5, aspects of assembly of a bendable flat heat pipe 100-m in accordance with various embodiments are provided. Device 100-m may be an example of aspects of device 100 of FIG. 1. The top portion of FIG. 5 shows several components, including a wick and vapor layer with multiple cross ribs 124-m along with a containment layer 110-m. The wick and vapor layer with multiple cross ribs 124-m may be an example of the wick and vapor layer 120 and cross ribs 130 of FIG. 1 (or the wick and vapor layer with cross ribs 124) and/or the wick and vapor layer with cross ribs 124-l of FIG. 4. The containment layer 110-m may be an example of the containment layer 110 of FIG. 1. In this example, the containment layer 110-m may be folded to form a first portion 110-m-1 and a second portion 110-m-2. Through folding the containment layer 110-m as shown, it may reduce the number of edges that may need to be sealed. It may also help facilitate placement of one or more charge tubes. It may also help with maintaining alignment of the portions of the containment layer 110-m. The wick and vapor layer with cross ribs 124-m may be shown prior to being positioned between the first portion 110-m-1 and the second portion 110-m-2. Charging tubes 150-m-1 and 150-m-2 are also shown, which may facilitate charging the bendable flat heat pipe 100-m with a working fluid.

The lower portion of FIG. 5 shows the bendable flat heat pipe 100-m after the wick and vapor layer with cross ribs 124-m may be contained between the first portion 110-m-1 of the containment layer 110-m and the second portion 110-m-2 of the containment layer 110-m, and thus may be obscured from view. The charging tubes 150-m-1 and 150-m-2 may be positioned proximal to the bend of the containment layer 110-m formed between the two portions 110-m-1 and 110-m-2. The free edges of the two portions 110-m-1 and 110-m-2 may be bonded together utilizing a variety of techniques, including diffusion bonding, welding, soldering, or other techniques. FIG. 7 shows an example of a resulting device.

FIG. 6 shows an exploded view a bendable flat heat pipe 100-n in accordance with various embodiments. Device 100-n may be an example of device 100 of FIG. 1. In this example, a wick and vapor layer 120-n may be shown positioned between a first cross rib structure 131-n-1 and second cross rib structure 131-n-2, which may be example of similar structures from FIG. 4. A first containment layer 110-n-1 and a second containment layer 110-n-2 may then contain the wick and vapor layer 120-n and the cross rib structures 131-n-1 and 131-n-2. In some embodiments, the wick and vapor layer 120-n may be bonded with the cross rib structures 131-n-1 and 131-n-2 prior to being positioned between the containment layers 110-n-1 and 110-n-2. The containment layers 110-n-1 and 110-n-2 may then be sealed or otherwise bonded together to contain the wick and vapor layer 120-n and the cross rib structures 131-n-1 and 131-n-2. FIG. 6 also shows charging tubes 150-n-1 and 150-n-2 that may be utilized to charge the bendable flat heat pipe 100-n.

Turning now to FIG. 7, bendable flat heat pipes 100-r and 100-r-1 are shown in accordance with various embodiments. In particular, the top portions of FIG. 7 shows device in a flat state, while the bottom portion of FIG. 7 shows device 100-r-1 in a bent or curved state. Device 100-r may be an example of device 100 of FIG. 1, FIG. 3, FIG. 5, and/or FIG. 6. Device 100-r-1 may show in particular an example where the containment layer may be folded such that the wick and vapor layer (with or without cross ribs) may be contained between a first portion and second portion of the containment layer, such as found with FIG. 3 and/or FIG. 5.

FIG. 8 shows a device 100-s in accordance with various embodiments. Device 100-s may be an example of devices 100 of FIG. 1, FIG. 5, FIG. 6, and/or FIG. 7. Device 100-s may be shown in particular with respect to cross ribs 130-s and containment layer 110-s-1.

FIG. 8 may show an example where containment layer 110-s may buckle when bent or curved. Cross ribs 130-s, however, may control the wavelength of the buckle such that the containment layer 110-s-1 does not buckle or otherwise impinge upon the wick and vapor layer 120-s. FIG. 8 may also show aspects of Euler bending. While device 100-s may include multiple cross ribs 130-s between wick and vapor layer 120-s and containment layer 110-s-1, some embodiments may also include cross ribs between wick and vapor layer 120-s and containment layer 110-s-2.

Turning now to FIG. 9, a system 900 in accordance with various embodiments is provided. System 900 may include a device 100-t, which may be an example of devices 100 of FIG. 1, FIG. 3, FIG. 5, FIG. 6, FIG. 7, and/or FIG. 8. Device 100-t shown in a bent or curved state may be thermally 911-a and/or mechanically 912-a coupled with a heat source 910. The device 100-t may also be thermally 911-b and/or mechanically 912-b coupled with a radiator 920. In some embodiments, the mechanical coupling 912-b may include a clamp.

FIG. 10 shows a flow diagram of a method 1000 is shown in accordance with various embodiments. Method 1000 may be implemented utilizing a variety of systems and/or devices such as those shown and/or described with respect to FIG. 1, FIG. 2A, FIG. 2B, FIG. 3, FIG. 4, FIG. 5, FIG. 6, FIG. 7, FIG. 8, and/or FIG. 9. Method 1000 may be referred to as a method of forming a bendable flat heat pipe.

At block 1010, a wick and vapor layer may be formed; the wick and vapor layer may include one or more wick channels and one or more vapor channels. At block 1020, the wick and vapor layer may be contained between one or more containment layers.

Some embodiments of the method 1000 include positioning multiple cross ribs between the wick and vapor layer and at least one of the one or more containment layers. Some embodiments include bonding the multiple cross ribs with the wick and vapor layer. Some embodiments include removing material from a metal layer to form the multiple cross ribs. Some embodiments include charging the bendable flat heat pipe with a working fluid.

Some embodiments of the method 1000 include forming the wick and vapor layer includes bonding multiple metal meshes with each other. In some embodiments, the multiple metal meshes include at least a first metal mesh and a second metal mesh where the first metal includes more pores per unit area than the second metal mesh.

In some embodiments of the method 1000, forming the wick and vapor layer includes removing material from one or more metal meshes that form the wick and vapor layer to form the one or more vapor channels. In some embodiments, containing the wick and vapor layer between the one or more containment layers include bonding the wick and vapor layer with the one or more containment layers. In some embodiments, containing the wick and vapor layer between one or more containment layers includes folding a first containment layer such that the wick and vapor layer is contained between a first portion of the first containment layer and a second portion of the first containment layer.

In some embodiments of the method 1000, the wick and vapor layer for bendable flat heat pipe may be formed through removing material from a wick structure to form one or more vapor channels. One or more cross ribs may be bonded laterally across the wick and vapor layer. The wick and vapor layer along with the one or more cross ribs may be positioned between one or more containment layers or between two portions of a containment layer. In some embodiments, these may be done as separate steps, while in other embodiments, these steps are done as a combined step. Diffusion bonding may be utilized to bond the different aspects together to form the heat pipe. The heat pipe may be filed with a working fluid.

These embodiments may not capture the full extent of combination and permutations of materials and process equipment. However, they may demonstrate the range of applicability of the method, devices, and/or systems. The different embodiments may utilize more or less stages than those described.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various stages may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the embodiments.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which may be depicted as a flow diagram or block diagram or as stages. Although each may describe the operations as a sequential process, many of the operations can be performed in parallel or concurrently. In addition, the order of the operations may be rearranged. A process may have additional stages not included in the figure.

Having described several embodiments, it will be recognized by those of skill in the art that various modifications, alternative constructions, and equivalents may be used without departing from the spirit of the different embodiments. For example, the above elements may merely be a component of a larger system, wherein other rules may take precedence over or otherwise modify the application of the different embodiments. Also, a number of stages may be undertaken before, during, or after the above elements are considered. Accordingly, the above description should not be taken as limiting the scope of the different embodiments.

What is claimed is:

1. A bendable flat heat pipe comprising:
one or more containment layers; and
a wick and vapor layer contained between the one or more containment layers, wherein the wick and vapor layer includes one or more wick channels and one or more vapor channels.

2. The bendable flat heat pipe of claim 1, further comprising a plurality of cross ribs positioned between the wick and vapor layer and at least one of the one or more containment layers.

3. The bendable flat heat pipe of claim 2, wherein the plurality of cross ribs are oriented across the one or more vapor channels and the one or more wick channels.

4. The bendable flat heat pipe of claim 3, wherein the plurality of cross ribs are bonded with the wick and vapor layer.

5. The bendable flat heat pipe of claim 1, wherein the wick and vapor layer includes one or more metal meshes.

6. The bendable flat heat pipe of claim 5, wherein the one or more metal meshes include a plurality of metal meshes that include at least a first metal mesh and a second metal mesh, wherein the first metal mesh includes more pores per unit area than the second metal mesh.

7. The bendable flat heat pipe of claim 6, wherein the plurality of metal meshes are bonded with each other.

8. The bendable flat heat pipe of claim 5, wherein the one or more vapor channels are formed from removing material from the one or more metal meshes of the wick and vapor layer.

9. The bendable flat heat pipe of claim 1, wherein the one or more containment layers includes a first containment layer that is folded to form a first portion and a second portion, wherein the wick and vapor layer is contained between the first portion of the first containment layer and the second portion of the first containment layer.

10. The bendable flat heat pipe of claim 1, wherein the one or more containment layers includes a first containment and a second containment layer, wherein the wick and vapor layer is contained between the first containment layer and the second containment layer.

11. The bendable flat heat pipe of claim 1, further comprising a working fluid contained within the bendable flat heat pipe.

12. A method of forming a bendable flat heat pipe comprising:
forming a wick and vapor layer, wherein the wick and vapor layer includes one or more wick channels and one or more vapor channels; and
containing the wick and vapor layer between one or more containment layers.

13. The method of forming the bendable flat heat pipe of claim 12, further comprising positioning a plurality of cross ribs between the wick and vapor layer and at least one of the one or more containment layers.

14. The method of forming the bendable flat heat pipe of claim 13, further comprising bonding the plurality of cross ribs with the wick and vapor layer.

15. The method of forming the bendable flat heat pipe of claim 12, wherein forming the wick and vapor layer includes bonding a plurality of metal meshes with each other.

16. The method of forming the bendable flat heat pipe of claim 15, wherein the plurality of metal meshes include at least a first metal mesh and a second metal mesh, wherein the first metal includes more pores per unit area than the second metal mesh.

17. The method of forming the bendable flat heat pipe of claim 14, wherein forming the wick and vapor layer includes removing material from one or more metal meshes that form the wick and vapor layer to form the one or more vapor channels.

18. The method of forming the bendable flat heat pipe of claim 12, wherein containing the wick and vapor layer between the one or more containment layers include bonding the wick and vapor layer with the one or more containment layers.

19. The method of forming the bendable flat heat pipe of claim 12, further comprising charging the bendable flat heat pipe with a working fluid.

20. The method of forming the bendable flat heat pipe of claim 12, wherein containing the wick and vapor layer between one or more containment layers includes folding a first containment layer such that the wick and vapor layer is contained between a first portion of the first containment layer and a second portion of the first containment layer.

21. The method of forming the bendable flat heat pipe of claim 13, further comprising removing material from a metal layer to form the plurality of cross ribs.
